(19) United States
(12) Patent Application Publication
(10) Pub. No.: US 2013/0173765 A1
(43) Pub. Date: Jul. 4, 2013

(54) SYSTEMS AND METHODS FOR ASSIGNING ROLES BETWEEN USER DEVICES

(71) Applicant: William Korbecki, Lake in the Hills, IL (US)

(72) Inventor: William Korbecki, Lake in the Hills, IL (US)

(73) Assignee: United Video Properties, Inc., Santa Clara, CA (US)

(21) Appl. No.: 13/340,108

(22) Filed: Dec. 29, 2011

(51) Int. Cl. G06F 15/177

(52) U.S. Cl. 709/221

(57) ABSTRACT

Systems and methods are provided that determine that user equipment devices are within a perceivable range (e.g., a viewing range) of the other. In response to this determination, roles may be assigned to the devices. These roles may be associated with profile settings on the devices that define how information is presented to the user within media guidance applications running on the devices. In some embodiments, the systems and methods may then determine that one of the user equipment devices is no longer within the perceivable range of the other user equipment devices. In response to this determination, the user device that is no longer within the perceivable range of the other devices may be assigned a role such that the presentation of information now occurs on that user device.

### BACKGROUND

When multiple devices are present at a location, such as a den in a home, they inherently compete for involvement in a user or user's entertainment experience. For example, a media guidance application may display reminders associated with a scheduled broadcast of a program. When a user leaves the viewing range of the television, they are unable to see the reminder and thus are unaware that it was ever displayed. Without methods and systems for developing an understanding of the devices available to a user as well as their location in relation to each other, it is difficult to create a display of information for the user.

### SUMMARY OF THE INVENTION

In view of the foregoing, systems and methods for determining roles for user devices are provided. These systems and methods generally detect the devices, resolve the type of the devices, determine the capabilities of the devices, and determine the distance, trajectory, and/or location of the devices in relation to one another. Using that information, roles are assigned to the devices such that a seamless presentation of information can be provided to the user of the devices.

In some embodiments, the systems and methods may determine that the devices are within a perceivable range (e.g., a viewing range) of the other. In response to this determination, roles may be assigned to the devices. These roles may be associated with profile settings on the devices that define how information is presented to the user within media guidance applications running on the devices. For example, it may be determined that a second of two user devices is within a perceivable range of a first of the user devices. In response to this determination, the first device may be assigned a primary device role, and the second device may be assigned a secondary device role. The primary device role may instruct the first device to execute a profile setting on the first device (e.g., to enable the display of media guidance reminders on the first device), and the secondary device role may instruct the second user device to not execute a profile setting on the second device (e.g., to disable the display of media guidance reminders on the second device).

In some embodiments, the systems and methods may then determine that one of the user equipment devices is no longer within the perceivable range of the other user equipment devices. In response to this determination, the user device that is no longer within the perceivable range of the other devices may be assigned a role such that the presentation of information now occurs on that user device. Continuing the example from the paragraph above, it may be determined that the second user device is no longer within a perceivable range of the first user device after a user carries the second user device outside of the room where the first user device is located. In response to this determination, the roles of the first and second user device may be switched such that the second user device is assigned the primary device role, and the first user device is assigned the secondary device role.

In some embodiments, the devices may broadcast device identifiers. In an embodiment, these device identifiers include a unique device identifier (e.g., a UUID), the device type, the capabilities of a device, and the location of the other devices in a room. In some embodiments, these device identifiers may be received by a server. The server may resolve the type of the devices based on the received device identifiers. In addition, the server may determine the capabilities of the devices based on the resolved device types. Also, the server may analyze the received information to determine the location of the devices in relation to one another. Finally, the server may assign roles to the devices based on the determined capabilities, the location of the devices, or both.

In some embodiments, the server may also receive a request to execute a behavior on a particular device, such as displaying a media guidance reminder on the particular device. The server may then enable the requested behavior across the devices in the room based on their assigned roles. Through this process, the requested device behavior may be modified to a different device behavior. For example, there may be two devices in a room: a tablet computer and a television. The server may determine that the television would be an optimal device for displaying media guidance reminders due to its screen size. Concurrently, the server may determine that the tablet computer will not display media guidance reminders when it is within a perceivable range of the television. Accordingly, as long as the tablet computer is within the perceivable range of the television, media guidance reminders may be displayed on the television rather than the tablet computer. However, if it is detected that the tablet computer is no longer within the perceivable range of the television, roles may be reassigned such that if a television requests to display a media guidance reminder, the media guidance reminder will be displayed on the tablet computer rather than the television.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative arrangement of user devices in accordance with another embodiment of the invention;

FIG. 6 shows an illustrative device identifier packet in accordance with another embodiment of the invention;

FIGS. 7 and 8 show illustrative display screens of menus for assigning roles to user devices in accordance with another embodiment of the invention; and

FIGS. 9-12 illustrate flow diagrams for assigning roles to user equipment devices in accordance with an embodiment of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

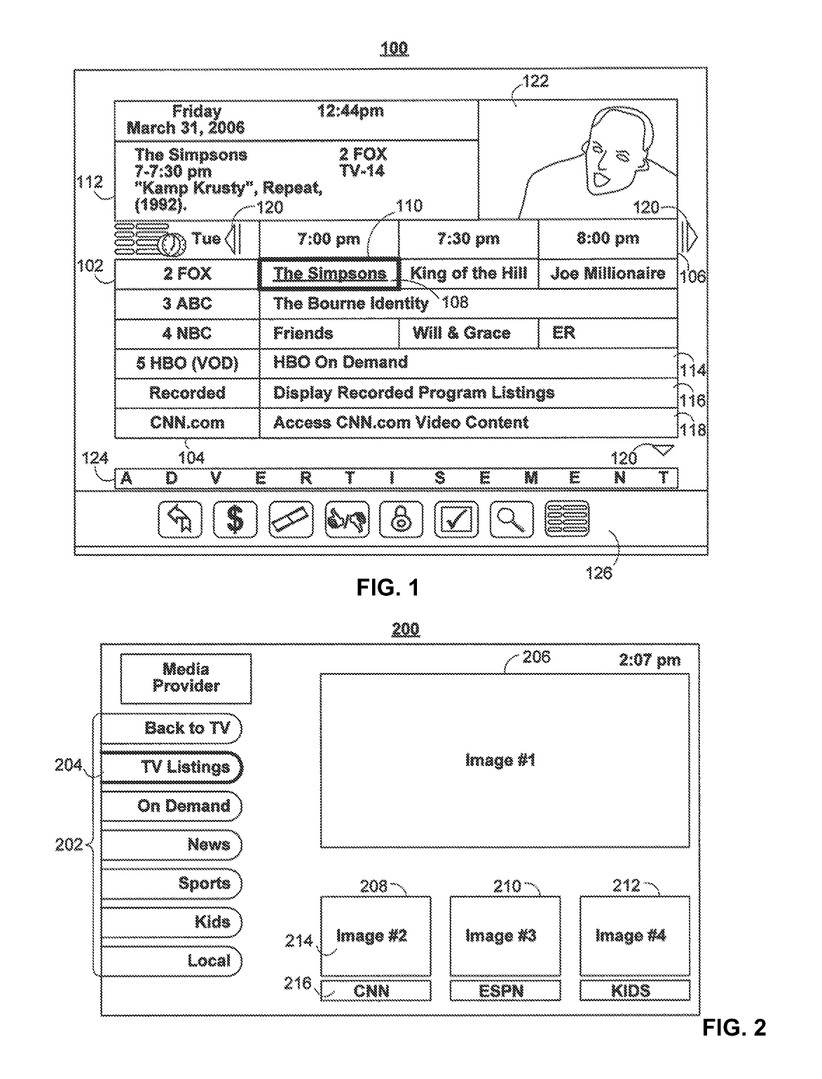

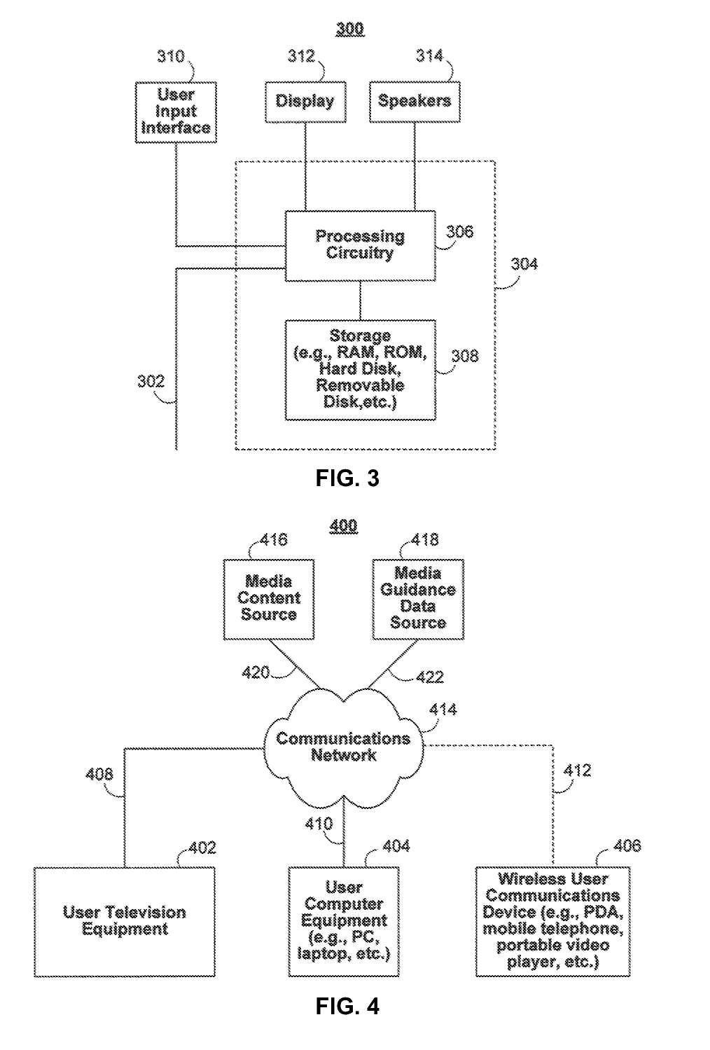

FIGS. 1-2 show illustrative display screens that may be used to provide media guidance data. The display screens shown in FIGS. 1-2 and 7-8 may be implemented on any suitable user equipment device or platform. While the displays of FIGS. 1-2 and 7-8 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. The various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

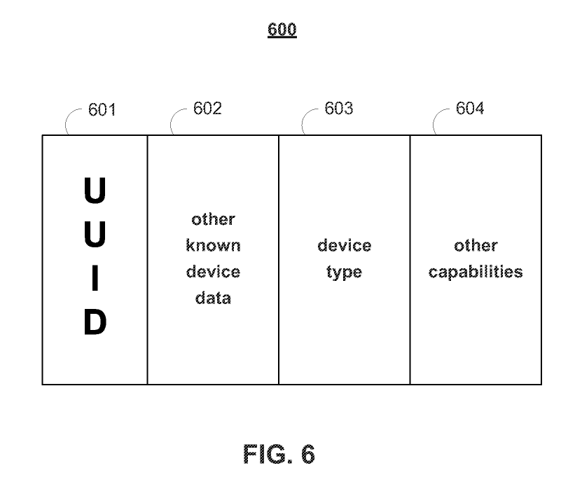

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

The media guidance application may allow a user or any suitable user equipment device to change a profile setting. As used herein, the phrase “profile setting” should be understood to mean any settings associated with a particular user profile within a media guidance application that convey information other than the video and audio of presented content itself. This information may include media guidance data (as defined above), media guidance reminders (e.g., messages that remind the user to watch or record content on various user equipment devices), information associated with content availability (e.g., messages that inform the user that on-demand or internet-based content (e.g., videos from Youtube, Hulu, or any internet-based video hosting service) associated with the presented content is available), social media communications (e.g., Twitter or Facebook posts discussing presented content), information associated with wired, cellular, internet based telephony (e.g., caller identification information, SMS or MMS messages, or any suitable information associated with incoming telephonic messages), chat sessions, or any other suitable information that is not the video and audio of presented content itself. In some embodiments, the profile setting may switch on or off the presentation of information to a particular user device. In other embodiments, the profile setting may vary the frequency of information presented (e.g., vary the frequency of social media communications presented such that a subset of the social media communications directed toward the user associated with the particular user profile is displayed).

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

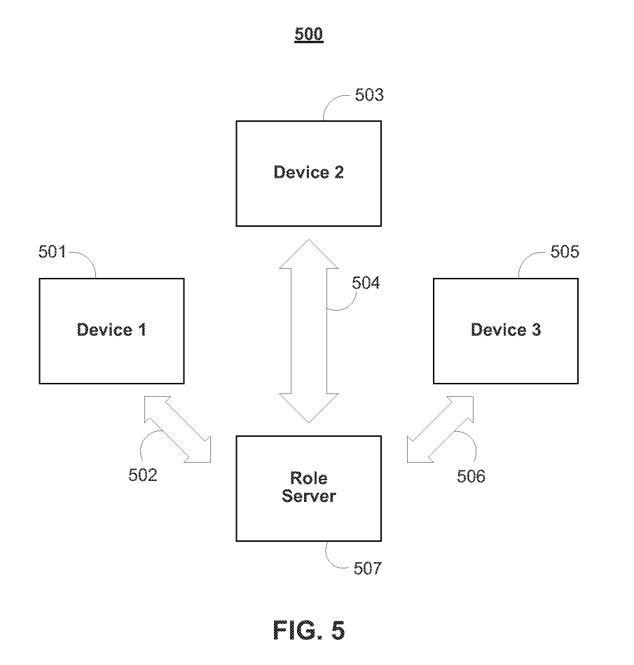

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

In some embodiments, control circuitry 304 may include detecting circuitry 307 (not shown) which may be capable of detecting and/or identifying one or more user equipment devices without requiring the user or users to make any affirmative actions. In an embodiment, detecting circuitry 307 may detect one or more user equipment devices by analyzing data gathered from an image sensor using any suitable computer vision technique, such as, for example, thresholding, image filtering, edge detection, template matching or any suitable computer vision technique. For example, a television using detecting circuitry 307 may use template matching to determine that a laptop and a tablet computer are located on a coffee table in front of the television. In some embodiments, the computer vision technique may be used to determine the type of user equipment device. For example, a television using detecting circuitry 307 may use template matching to determine from the logo on the back of a tablet computer that the type of tablet computer is an Apple iPad (as opposed to, for example, a Samsung Galaxy Tablet).

Detecting circuitry 307 may also be capable of detecting and/or identifying one or more user equipment devices by detecting and analyzing data from active or passive radio-frequency identification, Bluetooth signals, Wi-Fi signals, WiMax signals, IP tracing, infrared signals, any other suitable IEEE, industrial, or proprietary communication standards, or any other suitable electronic, optical, or auditory communication means. For example, detecting circuitry 307 may listen for communication packets transmitted over Bluetooth or Wi-Fi signals, and use data parsed or extracted from such packets in order to detect and/or identify one or more user equipment devices.

Detecting circuitry 307 may include any suitable hardware and/or software to perform detection and identification operations. For example, detecting circuitry may include infrared, optical, and/or radio-frequency receivers and/or transmitters. Detecting circuitry 307 may additionally, or alternatively, include one or more microphone and/or camera to detect audible and/or visual information, respectively. The microphone may be capable of receiving sounds within and/or beyond the audible range of one or more user equipment devices. The camera may be capable of capturing information within the visual spectrum and/or outside the visual spectrum. For example, the camera may be able to capture infrared information, ultraviolet information, or any other suitable type of information.

In some embodiments, detecting circuitry 307 may use any suitable method to determine the distance, trajectory, and/or location of one user equipment device in relation to another user equipment device. For example, a media device may use received signal strength indication (RSSI) from a user's mobile device to determine the distance one user equipment device is to another user equipment device. For example, RSSI values may be triangulated to determine a location of one user equipment device in relation to another user equipment device. The media device may also use, for example, time difference of arrival values of sounds emanating from another device to determine a location of one user equipment device in relation to another user equipment device. In some embodiments, any suitable image processing, video processing, and/or computer vision technique may be used to determine one device's distance, trajectory, and/or location in relation to another user equipment device.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on the various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. In some embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

It will be appreciated that while the discussion of media content has focused on video content, the principles of media guidance can be applied to other types of media content, such as music, images, etc.

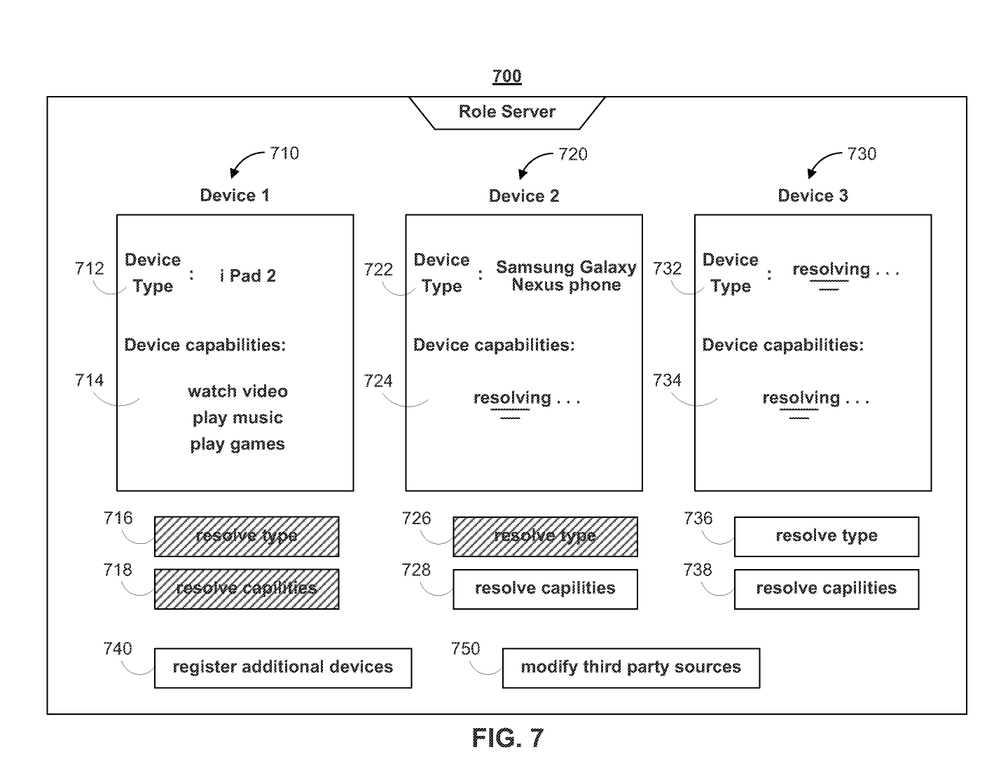

FIG. 5 shows an illustrative arrangement of user equipment devices 500 in accordance with another embodiment of the invention. In some embodiments, user equipment devices 500 may be substantially similar to user equipment devices 402, 404, and 406 (FIG. 4). In some embodiments, user equipment devices may comprise one, two, three, five, ten, fifteen, twenty, or more than twenty user equipment devices. As illustrated in FIG. 5, user equipment devices include first user device 501, second user device 503, third user device 505, and role server 507. In some embodiments, user equipment devices 500 may be located in the same vicinity, such as the same room within a home or apartment (i.e., the living room or den). In such embodiments, role server 507 may assign roles to user equipment devices 500 such that they act in concert to provide a seamless entertainment experience within the room. In one example, first user device 501 may be assigned the role of a primary display device (e.g., for watching movies or playing games), second user device 503 may be assigned the role of a primary information device (e.g., for displaying content directly associated with a movie played on the primary display device such as subtitles or other informational features), and third user device 505 may be assigned the role of secondary information device (e.g., for displaying content indirectly associated with a movie played on the primary display device such as a web page or interactive feature). In another example, first user device 501 may be assigned the role of a primary reminder device (e.g., for displaying reminders within a media guidance application displayed on first user device 501), and second user device 503 may also be assigned the role of primary display device (e.g., for displaying reminders within a media guidance application displayed on second user device 503).

In other embodiments, user equipment devices 500 may not be located in the same vicinity of each other. In such embodiments, role server 507 may adjust the roles of user equipment devices such that they provide a seamless entertainment experience across a number of locations within a home or apartment. In one example, first user device 501 may be assigned the role of a primary display device (e.g., for watching movies or playing games in the living room), second user device 503 may be assigned the role a secondary display device (e.g., for mirroring the movie displayed on the primary display device when the user leaves the living room), and third user device 505 may be assigned the role of primary information device (e.g., for displaying the progress of the movie displayed on the primary and/or secondary display device when the user leaves the living room). In another example, first user device 501 may be assigned the role of primary reminder device (e.g., for displaying reminders within a media guidance application displayed on first user device 501), and second user device 503 may be assigned the role of secondary reminder device (e.g., for displaying reminders within a media guidance application displayed on second user device 503 when second user device 503 is not located within the same room as first user device 501).

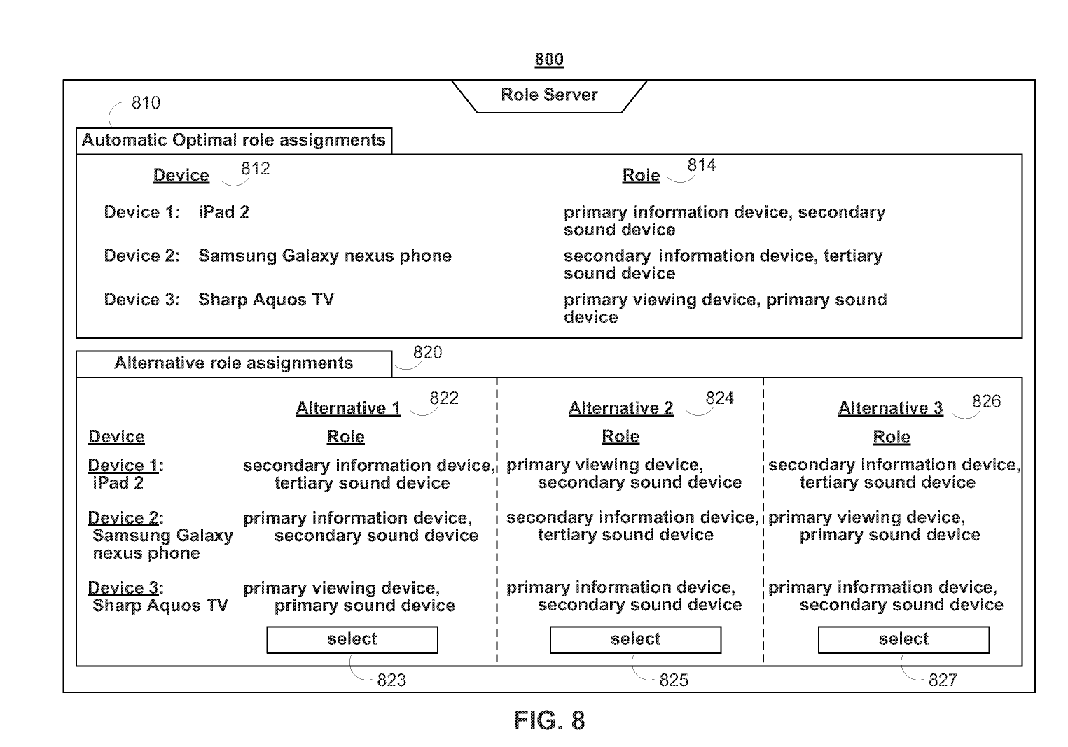

As will be described in FIGS. 6-12, role server 507 may assign roles to user equipment devices 500 such as first user device 501, second user device 503, and third user device 505 such that user equipment devices 500 perform behaviors to create a seamless entertainment experience for the user within a particular location. To this end, user equipment devices 500 may contain control circuitry that is enabled to determine the location of the user equipment devices 500. In some embodiments, the control circuitry may be the circuitry that provides wireless connectivity to the user equipment devices 500. In some embodiments, the control circuitry may be GPS circuitry.

In some embodiments, first user device 501, second user device 503, and third user device 505 communicate with role server 507 through communication paths 502, 504, and 506, respectively. Communication paths 502, 504, and 506 may be substantially similar to paths 408, 410, and 412 (FIG. 4). In some embodiments (not shown), user equipment devices 500 may communicate with each other through any suitable configuration of communication paths between first device 501, second device 502, and third device 503.

In some embodiments, one or more of first device 501, second device 503, and third device 505 may be hand-held computers (i.e. tablet computers such as iPads or laptop personal computers), PDAs, mobile music devices (i.e. iPods such as iPod classic or iPod touch, or Android-based music devices), mobile telephones (i.e., iOS or Android based smartphones), or other mobile devices. In some embodiments, one or more of first device 501, second device 503, and third device 505 may be “over-the-top” home entertainment equipment such as wireless-communication enabled televisions, blu-ray players, DVD players, personal media servers (i.e., a Boxeee box or Roku device), or any other suitable wireless-communication enabled home entertainment equipment that delivers OTT content. For example, first device 501 may be an Ipad 2, second device 503 may be a Samsung Galaxy Nexus phone, and third device 505 may be a Sharp Aquous LCD television. In some embodiments, not all of user equipment devices 500 may be capable of utilizing communication paths to communicate with role server 507 or with each other. For example, the iPad 2 and the Samsung Galaxy Nexus phone may be able to communicate with role server 507 and with each other, but the Sharp Aquous television may not be able to communicate with the role server or with the iPad 2 and the Samsung Galaxy Nexus phone. In such embodiments, those user equipment devices 500 that are not able to communicate with role server 507 may need to be manually identified to role server 507 by a user such that they may be assigned roles and perform behaviors in concert with other user equipment devices 500.

In some embodiments, role server 507 may be stationary computing equipment such as a personal computer, “over-the-top” home entertainment equipment such as that described above, or any other suitable computing equipment. In other embodiments, role server 507 may be a mobile device such as that described above with respect to first device 501, second device 503, and third device 505. In some embodiments, functionality of role server 507 may be performed by physically separate hardware from first device 501, second device 503, and third device 505. In other embodiments, some or all of the functionality of role server 507 may be performed by one or more of first device 501, second device 503, and third device 505. In any case, role server 507 assigns roles and subsequently dictates behaviors to user equipment devices 500. As will be described in FIGS. 6-13, in order to assign roles and dictate behaviors, role server 507 determines the type and capabilities of user equipment devices 500.

In some embodiments, one or more of user equipment devices 500 and/or role server 507 may use detecting circuitry 307 to configure one or more detection regions substantially similar to the detection configuration screen described with respect to FIG. 6 of Shimy et al. U.S. Patent Publication No. 2011/0069940 (Docket No. UV-495A), published Mar. 24, 2011, which is incorporated by reference herein in its entirety. Using such techniques, a user or device may manually or automatically define a detectable or perceivable range between one user equipment device and/or role server and other user equipment devices and/or role servers. User equipment devices 500 and/or role server 507 may then detect when a particular user equipment device is within the perceivable range, or is no longer within the perceivable range, similar to the systems and methods described in U.S. Patent Publication No. 2011/0069940.

In order for role server 507 to determine the type and capabilities of user equipment devices 500, a packet of information may be generated by one or more of the user equipment devices 500 to be transmitted or broadcast to role server 507. FIG. 6 shows a device identifier packet 600 in accordance with another embodiment of the invention. Device identifier packet 600 may be generated and transmitted by one or more of user equipment devices 500 in order to coordinate the assignment of roles between user equipment devices 500. In an embodiment, device identifier packet 600 may include a header (not shown) in order to identify to one or more of the fields in device identifier packet 600. This header may be of any suitable length and structure in order to identify the number and type of fields within device identifier packet 600, such as fields 601 through 604 illustrated in FIG. 6. In some embodiments, device identifier packet 600 may be generated and transmitted by one or more of user equipment devices 500 according to any suitable data transmission techniques utilizing any suitable communication path.

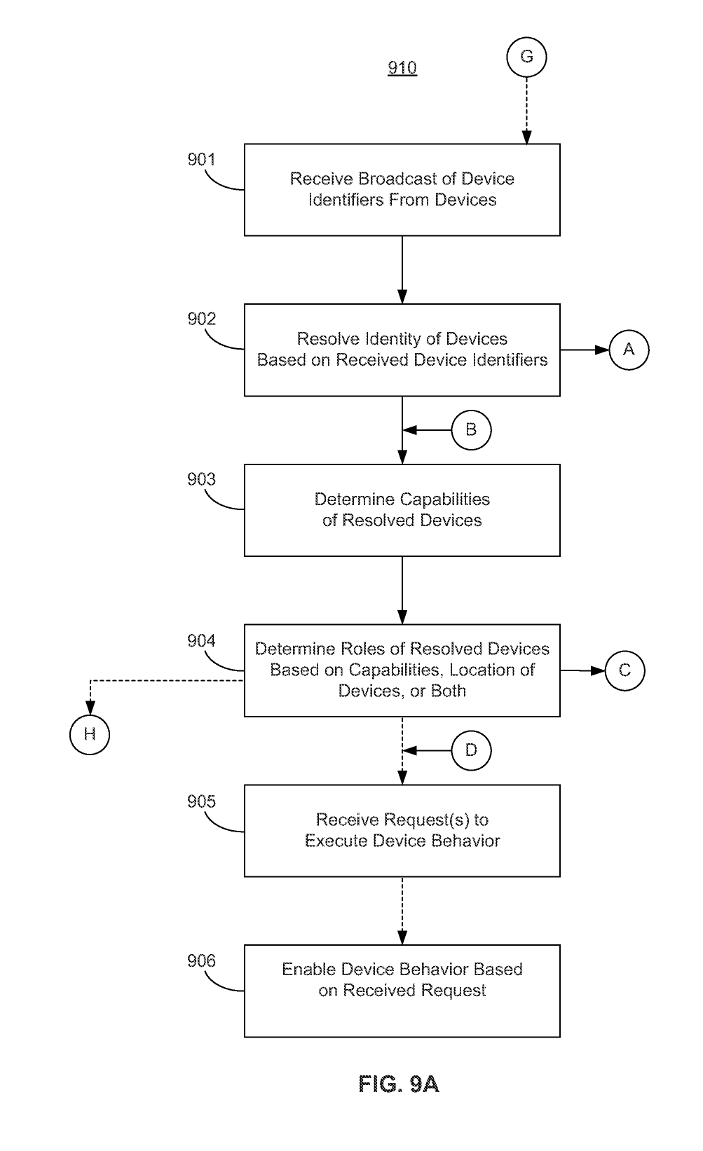

In some embodiments, device identifier packet 600 may contain universally unique identifier (“UUID”) field 601. An UUID is an identifier standard created by the Open Software Foundation as part of the Distributed Computing Environment. UUIDs enable distributed systems to uniquely share information through the generation and distribution of unique identifiers. In some embodiments, user equipment devices 500 are labeled with UUIDs such that they can be uniquely identified with near certainty without needing to resolve name conflicts. In one example, the UUID may specify that a device in user equipment devices 500 is a specific brand, type, and/or version of device, such as an Ipad 2, Samsung Galaxy Nexus phone, or Sharp Aquous television. In another example, the UUID may specify that a device in user equipment devices 500 is a generic brand, type, and/or version of device, such as a tablet computer, smartphone, “over-the-top” home entertainment equipment, or any other suitable generic type of user equipment device. As will be described with respect to FIGS. 7-13, role server 507 may use UUID field 607 to identify the type and capabilities of one of more user equipment devices 500.

In some embodiments, UUID field 601 may be generated by the particular user equipment device that UUID field 601 identifies, such as first device 501, second device 503, and third user device 503. In an embodiment, the UUID generated for UUID field 601 of device identifier packet 600 may be predetermined. For example, one or more of user equipment devices 500 may be programmed by the manufacturer with a UUID that is accessible to software executed on the user equipment devices 500 that generates device identifier packet 600. In an embodiment, the UUID generated for UUID field 601 of device identifier packet 600 may be retrieved from a third party database accessible to one of user equipment devices 500. For example, one of user equipment devices 500 may transmit a query to a third party database such as the Amazon Product Advertising API in order to retrieve information to help that user equipment device to generate a UUID consistent with other UUIDs generated for that exact device. This information may include the ISBN or UPC code associated with a product. In another example, one of user equipment devices may directly retrieve a UUID from a third party database. In some embodiments, UUID field 601 may be generated based on user input. In one example, a user of one of user equipment devices 500, such as first device 501, second device 503, and third device 505, may directly input a UUID to that user equipment device. In another example, the user of one of user equipment devices 500 may be provided with drop down menus or lists on the display of that user equipment device of UUIDs associated with specific or generic brands, types, and/or versions devices. In another example, the user of role server 507 may directly indicate (i.e., input) a UUID associated with a particular one of user equipment devices 500. In another example, a user of role server 507 may provide a user with drop down menus or lists on a display associated with role server 507 of UUIDs associated with specific or generic brands, types, and/or versions of devices.

In some embodiments, device identifier packet 600 may contain other known device data field 602. In an embodiment, other known device data field 602 may indicate what other devices besides the device transmitting device identifier packet 600 are at a particular location. In one example, other known device data field 602 may indicate what other devices are within a room within an apartment or home. In another example, other known device data field 602 may indicate what other devices are within or are not within the perceivable range of role server 507 (i.e., data in other known device data field 602 may indicate that a device may have been carried into a different room of a home or apartment than role server 507 such that the device is no longer within the perceivable range of role server 507). In an embodiment, other known device data field may indicate one or more of the received signal strength between user equipment devices 500 and/or role server 507, a time difference of arrival values of a sound emanating from one or more user equipment devices 500 and/or role server 507, or an image taken by one of the user equipment devices 500 and/or role server 507 depicting one or more of the other user equipment devices 500 and/or role server 507. This data may then be analyzed by the detecting circuitry 307 of one of the user equipment devices 500 in order to determine whether a particular one of user equipment devices 500 and/or role server 507 is within a perceivable range of user equipment devices 500 and/or role server 507, or is no longer within a perceivable range of user equipment devices 500 and/or role server 507. In an embodiment, other known device data field 602 may indicate the UUIDs of the other devices at a particular location or within a perceivable range of a location. In another embodiment, other known device data field 602 may explicitly indicate the exact type and capabilities of other devices at a particular location. In other embodiments, other known device data field 602 may explicitly indicate the exact types of other devices at a particular location, but not their capabilities. In yet another embodiment, other known device data field 602 may explicitly indicate the generic type of other devices at a particular location. In some embodiments, role server 507 may use other known device data field 602 to determine or estimate the type of one of user equipment devices 500.

In some embodiments, other known device data field 602 may be generated by the particular user equipment device that UUID field 601 identifies, such as first device 501, second device 503, and third user device 505. For example, other known device field 602 may be generated by second device 503, and other known device field 602 may indicate the type and capabilities of first device 501 and third device 503. In some embodiments, a user equipment device may gather data for other known device data field 602 by listening for broadcasts of UUIDs from other user equipment devices in a particular location. In some embodiments, a user equipment device may gather data for other known device data field 602 by interacting with other devices at a particular location. For example, when a tablet computer transmits information to a television, the tablet computer may add the television to a list of devices that populate other known device data field 602. In some embodiments, a user equipment device may gather data for other known device data field 602 by receiving user input. This user input may be user selection of other known devices from conventional lists and drop down menus.

In some embodiments, device identifier packet 600 may contain device type field 603. In an embodiment, device type field 603 may indicate the type of the device is that is transmitting device identifier packet 600. In some embodiments, device type field 603 may indicate a generic device type. For example, device type field 603 may indicate that a device is a particular brand and version of a tablet computer, such as an iPad 2, or a particular brand and version of a smartphone, such as a Samsung Galaxy Nexus phone. In some embodiments, device type field 603 may indicate that a device is a generic type of device. For example, device type field 603 may indicate that a device is a generic type of computing device, such as “tablet computer” or “laptop computer”, or is a generic type of home entertainment equipment, such as “LCD television” or “Blu-ray player”.

In some embodiments, device type field 601 may convey the same information as UUID field 601. However, in some embodiments, the difference between these fields is that UUID field 601 may indirectly indicate the type of device, while device type field 603 may directly indicate the type of device. For example, UUID field 601 may be a string of hexadecimal digits representing the device type for an iPad 2, while device type field 603 may be a string of text reading “iPad 2”.

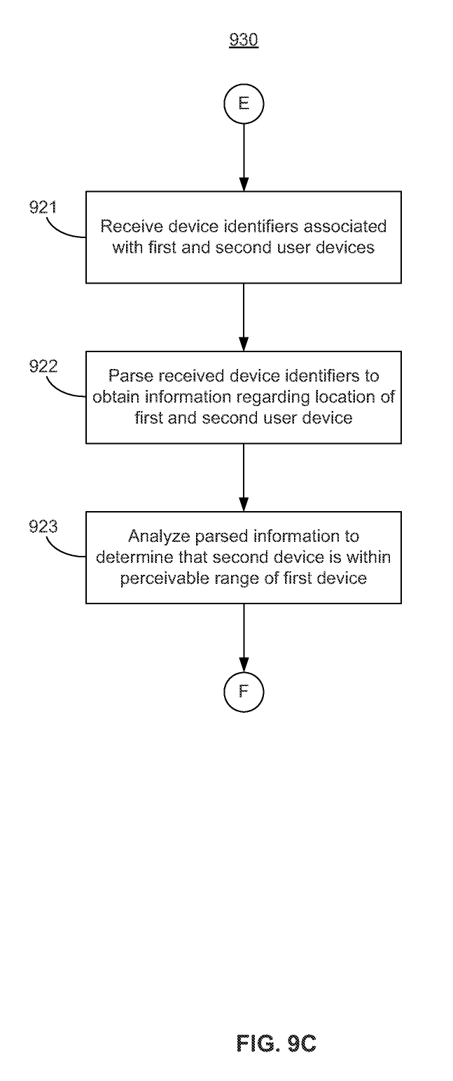

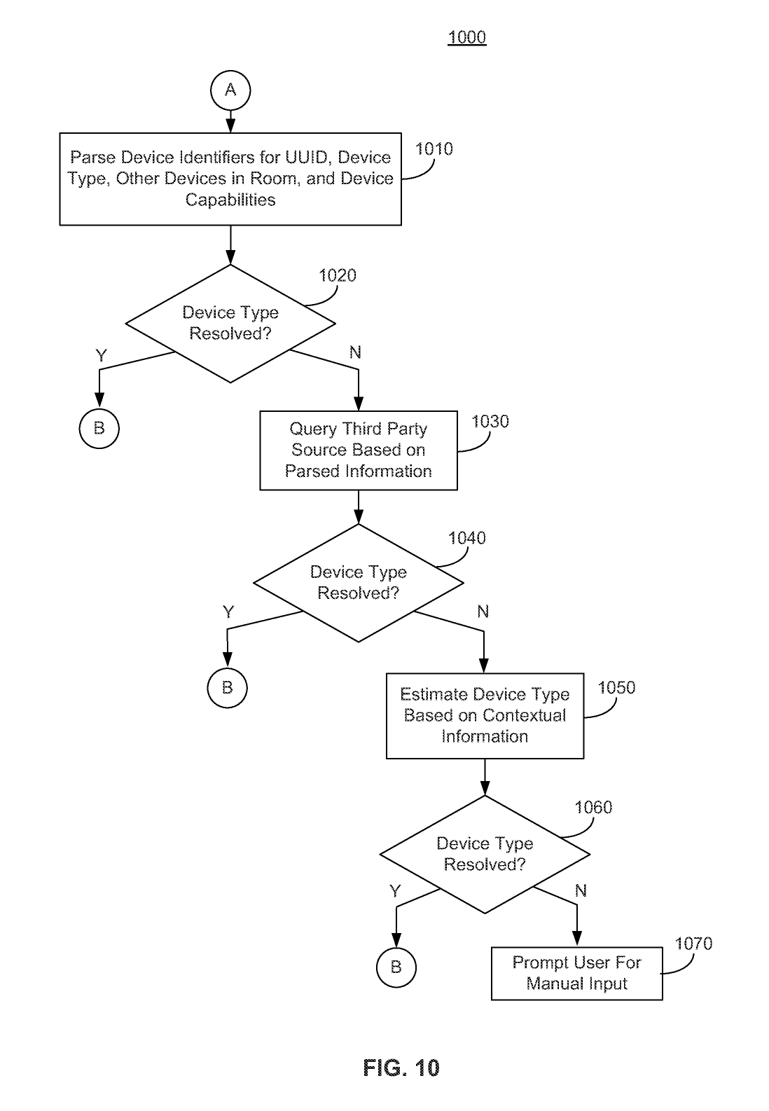

In some embodiments, device type field 603 may be generated by analyzing other pieces of information in device identifier packet 600. For example, as will be described in FIGS. 9-10, one or more of the information in UUID field 601, other known device data field 602, and device capabilities field 604 may be analyzed to determine the information in device type field 603. In some embodiments, the information in device type field 603 may be predetermined. In an embodiment, the information in device type field 603 may be hardcoded in software running on a particular user equipment device. In such embodiments, device type field 603 is generated by retrieving the hardcoded value and placing it into device type field 603 in device identifier packet 600. In some embodiments, the information in device type field 603 may be based on received user input. This user input may be user selection of other known devices from conventional lists and drop down menus.

In some embodiments, device identifier packet 600 may contain device capabilities field 604. In an embodiment, device capabilities field 604 may indicate one or more of the functionality and features of the particular device that transmits device identifier packet 600. For example, these capabilities may include one or more of display size (e.g., “4.5 inch display” and “40 inch display”), display type (e.g., “AMOLED display”, “LCD display”, and “e-ink display”), display resolution (e.g., “480×320 pixels” and “WXGA resolution”), processor speed (e.g., “500 Mhz” and “1.2 Ghz”), processor performance (e.g., “4.8 GFLOPS”), memory technology (e.g., “DDR2 667 Mhz”), CPU Instruction set (e.g., “ARMv7” and “x86-64”), GPU speed (e.g., “300 Mhz”), user input capabilities (e.g., “touch screen input”, “joystick”, and “QWERTY keyboard”), compatible video playback CODECS (e.g., “H.264”, “Adobe Flash 8.0”, and “WMV”), compatible audio CODECS (e.g., “AIFF”, “WAV”, or “MP3”), communication capabilities (e.g., “Bluetooth 3.0” or “802.11g”) or any other suitable descriptions of device capabilities.

In some embodiments, device capabilities field 604 may be generated by analyzing other pieces of information in device identifier packet 600. For example, as will be described in FIGS. 9A and 9B, one or more of the information in UUID field 601, other known device data field 602, and device type field 603 may be analyzed to determine the information in device capabilities field 604. In some embodiments, the information in device capabilities field 604 may be predetermined. For example, in an embodiment, the information in device capabilities field 604 may be hardcoded in software running on a particular user equipment device. In such embodiments, device capabilities field 604 is generated by retrieving the hardcoded values and placing them into device capabilities field 604 in device identifier packet 600. In some embodiments, the information in device capabilities field 604 may be based on received user input. This user input may be user selection of other known devices from conventional lists and drop down menus.

FIG. 7 shows an illustrative display screen of a menu 700 for assigning roles to user devices in accordance with another embodiment of the invention. In some embodiments, menu 700 may be displayed on a display device associated with a role server, such as role server 507 (FIG. 5). In other embodiments, menu 700 may be displayed on a display device associated with one or more user equipment devices, such as one or more of user equipment devices 500 (FIG. 5). Menu 700 includes panels 710, 720, and 730. In some embodiments, each of panels 710, 720, and 730 represent the status of resolution of the type and capabilities for a particular user equipment device (e.g., user equipment devices 500 (FIG. 5)). Although FIG. 7 shows only three panels, it shall be understood that menu 700 may contain any suitable number of panels, each corresponding to a user equipment device at a particular location. In the particular example shown in FIG. 7, panel 710 displays the resolution of the device type and capabilities of an iPad 2, panel 720 displays the resolution of the device type and capabilities of a Samsung Galaxy Nexus phone, and panel 730 displays the resolution of the device type and capabilities of a Sharp Aquous LCD television. In some embodiments, menu 700 illustrates the resolution of the type and capabilities of devices that are at a particular location, such as in the same room of a home or apartment. In other embodiments, menu 700 illustrates the resolution of the type and capabilities of devices that are across multiple locations, such as devices that in use across multiple homes or apartments, or in use across a home and a vehicle.

Panel 710 includes device type display 712 and device capabilities display 714. In some embodiments, device capabilities display 714 may contain generic device capabilities. For example, as shown, device type display 712 is resolved and reads “iPad 2”, and device capabilities display 714 is resolved and reads “watch video”, “play music”, and “play games”. In another example, device type display 712 convey the device capabilities “display media guidance reminders”, “display text messages”, “display called identification”, “display social media communications”, or any other capabilities associated with a profile setting as described above. In other embodiments, device capabilities display 714 may display more device specific device capabilities, such as “watch H.264 encoded video” or “play FLAC music files”. In some embodiments, device capabilities display 714 may display any device capabilities associated with an “iPad 2”, such as those described with respect to device capabilities field 604 (FIG. 6).

Panel 710 also includes resolve type option 716 and resolve capabilities option 718. In some embodiments, if the role server or user equipment device performing the functionality of the role server cannot resolve the type and/or capabilities of the user equipment device, a user may select resolve type option 716 and resolve capabilities option 718 in order to input the type and/or capabilities of the user equipment device. In some embodiments, resolve type option 716 and resolve capabilities option 718 may allow the user to manually resolve these features by, for example, explicitly providing information or selecting options from a drop-down menu. As shown in FIG. 7, because device type display 712 and device capabilities display 714 indicate that the device type and device capabilities have been resolved, resolve type option 716 and resolve capabilities option 718 are displayed as “grayed out” and cannot be selected.

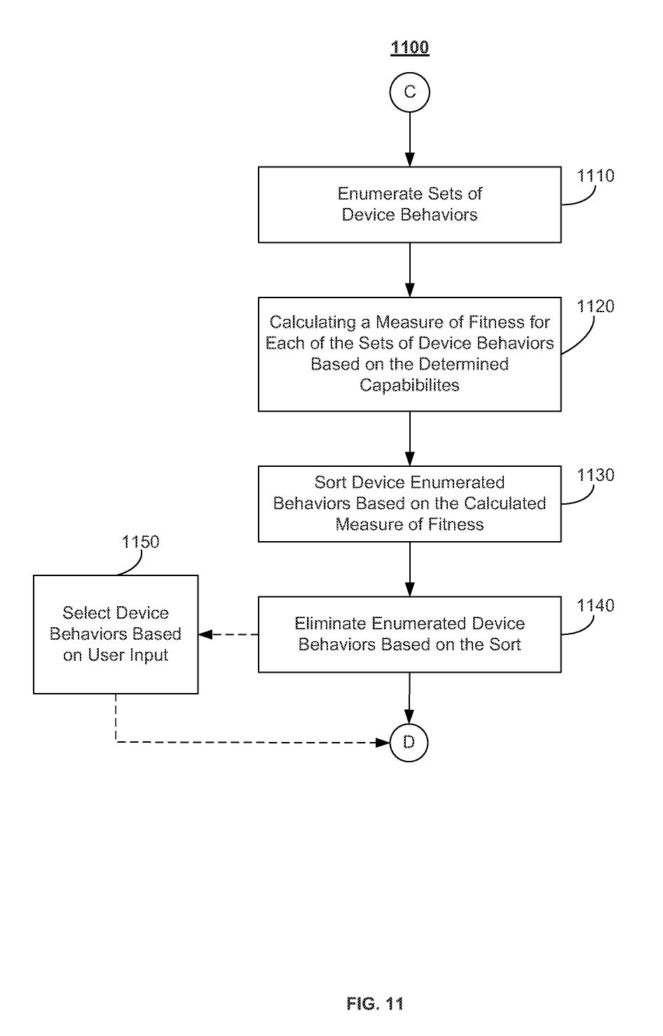

Panel 720 includes device type display 722 and device capabilities display 724. As shown in FIG. 7, device type display 722 reads “Samsung Galaxy Nexus phone” and device capabilities display 724 reads “resolving”. In an embodiment, this “resolving” message indicates that the role server or user equipment device performing the functionality of the role server is in the process of resolving the device capabilities. In some embodiments, this process occurs according to the processes described with respect to FIGS. 9A and 11. Panel 720 also includes resolve type option 726 and resolve capabilities 728, which are substantially similar to resolve type option 716 and resolve capabilities option 718, respectively. As shown in FIG. 7, because the device type shown in device type 722 has been resolved, resolve type option 726 is “grayed out” and cannot be selected. However, because the device capabilities of the user equipment device associated with panel 720 are in the process of being resolved, resolve capabilities option 728 is indicated as available and may be selected by the user. In some embodiments, once user selects resolve capabilities option 728, a menu (not shown) is displayed that allows the user to manually input the capabilities of the user second associated with panel 720 by, for example, typing in features or selecting them from a drop-down menu.

Panel 730 includes device type display 732 and device capabilities display 734. As shown in FIG. 7, because device type display 732 reads “resolving” and device capabilities display 734 reads “resolving”, this indicates that the role server or user equipment device performing the functionality of the role server is in the process of resolving the type of device, as well as resolving the device capabilities. In some embodiments, the process of resolving the type of device may occur as described in FIGS. 9A and 10. In some embodiments, the process of resolving the capabilities of the device occurs according to the process described in FIG. 9A. Panel 730 also includes resolve type option 736 and resolve capabilities option 738. As shown in FIG. 7, because both the device type and device capabilities of the device associated with panel 730 are unresolved, both resolve type option 736 and resolve capabilities option 738 may be selected by the user. In some embodiments, once a user selects resolve type option 736, a menu (not shown) is displayed that allows the user to manually input the type of device associated with panel 730 by, for example, typing in the device type or selecting them from a drop-down menu. The functionality of resolve capabilities option 738 may be substantially similar to resolve capabilities option 728.

In some embodiments, menu 700 may include register additional devices option 740. Once a user selects register additional devices option 740, an additional menu (not shown) may be displayed that allows the user to manually input information associated with devices which have not been detected by the role server or the user equipment devices performing the functionality of the role server. For example, one or more of user equipment devices 500 may not be able to communicate with role server 507. A user may then use register additional devices option 740 to register the device with role server 507 in order to assign one or more roles to those devices such that they may provide a seamless home entertainment experience alongside those devices represented in panels 710, 720 and 730.

In some embodiments, menu 700 may include modify third party sources option 750. Once a user selects modify third party sources option 750, an additional menu (not shown) may be displayed that allows the user to select one or more databases that are used to resolve device type and/or device capabilities.

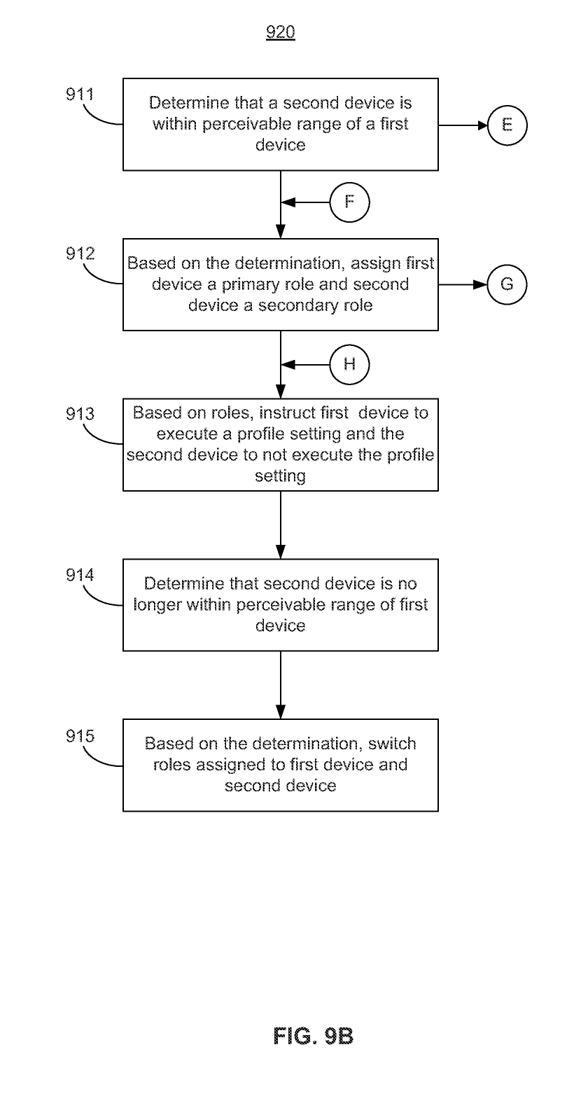

FIG. 8 shows an illustrative display screen of a menu 800 for assigning roles to user devices in accordance with another embodiment of the invention. Similar to menu 700 (FIG. 7), in some embodiments menu 800 may be displayed on a display device associated with a role server, such as role server 507 (FIG. 5). In other embodiments, menu 800 may be displayed on a display device associated with one or more user equipment devices, such as one or more of user equipment devices 500 (FIG. 5). Menu 800 includes panels 810 and 820. In some embodiments, each of panels 810 and 820 represent the status of resolution of the type and capabilities for a particular user equipment device (e.g., user equipment devices 500 (FIG. 5)). In some embodiments, menu 800 illustrates the assignment of the roles and associated behaviors of devices that are at a particular location, such as in the same room of a home or apartment. In other embodiments, menu 800 illustrates the assignment of the roles and associated behaviors of devices that are across multiple locations, such as devices that in use across multiple homes or apartments, or in use across a home and a vehicle.

Panel 810 lists the automatic optimal role assignments for one or more devices. In some embodiments, the automatic optimal role assignments may be determined by a role server (e.g., role server 507 (FIG. 5)). In other embodiments, the automatic optimal role assignments may be determined by the user equipment devices performing the functionality of the role server (e.g., one or more of user equipment devices 500 (FIG. 5)). In some embodiments, these automatic optimal role assignments are determined without any user input. For example, the automatic optimal role assignments may only be based on information obtained from third party sources, and information available from device identifier packet 600 (FIG. 6).

Panel 810 includes device column 812 and role assignment column 814. In some embodiments, device column 812 may list a number of devices and their associated type. For example, as shown in device column 812, three devices are listed: an iPad 2, a Samsung Galaxy Nexus phone, and a Sharp Aquous television. In some embodiments, the devices listed in device column 812 may be the same as those that were associated with panels 710, 720, and 730 of menu 700 (FIG. 7). In some embodiments, the devices listed in device column 812 may not all be resolved. In such embodiments, device column 812 may indicate to the user that the type of the device is in the process of being resolved. For example, one line of device column 812 may read “Device 3: resolving” to indicate that the type of a first device is unknown and in the process of being resolved. In some embodiments, a user may select the text of device column 812 in order to resolve or correct the resolved type of a device. This manual device type resolution may be substantially similar to resolve type option 716, resolve type option 726, and resolve type option 736 (FIG. 7).

In some embodiments, role assignment column 814 may list the roles assigned to the devices listed in device column 812. In some embodiments, role assignment column 812 may contain a listing of one or more roles that have been determined as optimal for the associated devices. These roles may describe a behavior that a user equipment device may perform, such as watching video, viewing information, playing a game, or any suitable device behavior. In some embodiments, the roles assigned to each of the devices may not overlap with respect to the behavior they provide in the context of the user's overall entertainment experience. In one example, panel 810 may show that the iPad 2 has been assigned the role of information device, the Samsung Galaxy Nexus phone has been assigned the role of game device, and the Sharp Aquous television has been assigned the roles of viewing device and sound device. In this example, if the user were to request playback of a video in the video player of the iPad 2, the Sharp Aquous television may display the video and sound associated with the video, the iPad 2 may display an information screen associated with the video, such as a screen of media guidance information associated with the video, and the Samsung Galaxy Nexus phone may provide the user with an interactive game associated with the video, such as a scavenger hunt or “I Spy” game associated with the video.

In other embodiments, the same role may be assigned to more than one user device, but that role may be qualified with a priority. This priority may indicate an order or preference in which particular user equipment devices may perform particular requested behaviors, or components of requested behaviors. For example, as shown in FIG. 8, panel 810 shows that the iPad 2 has been assigned the roles of primary information device and secondary sound device, the Samsung Galaxy Nexus phone has been assigned the roles of secondary information device and tertiary sound device, and the Sharp Aquous television has been assigned the role of primary viewing device and primary sound device. In this example, if the user were to request playback of a video in a video player on the iPad 2, the Sharp Aquous television may display the video and play the audio associated with the video because it has been assigned the role of primary viewing device and primary sound device. Concurrently, the iPad 2 may display an information screen associated with the video, such as a web page from imdb.com, because it is the primary information device. Additionally, the iPad 2 may play sounds associated with the navigation of the video but are not part of the video itself, such as sound effects triggered by the user's navigation through the video, because it is the secondary sound device. Further, the Samsung Galaxy Nexus phone may display other information associated with the movie, such as a chat room or social media profile associated with the content in the video, because it is the secondary information device. Further, the Samsung Galaxy Nexus phone may play sounds associated with secondary information (e.g., the chat room or twitter profile associated with the content in the video) because it is the tertiary sound device.

In some embodiments, the role assignment columns may list roles associated with profile settings. For example, panel 810 may show that the iPad 2 has been assigned the role of secondary reminder device while the Sharp Aquous television has been assigned the role of primary reminder device. In this example, if a reminder to watch or record content is to be displayed to a user, the reminder will be displayed on the Sharp Aquous television, but not on the iPad 2, as long as the iPad 2 is within a perceivable range of the television. If it is determined that the iPad 2 is no longer within the perceivable range of the Sharp Aquous television, these roles may be switched such that the reminders are displayed on the iPad 2 rather than the television.

Panel 820 includes alternate role assignment columns 822, 824, and 826. In some embodiments, the alternate role assignment columns displayed in panel 820 may include one or more alternative combinations of roles assigned to the user equipment devices. As will be described with respect to FIGS. 9A and 11, these alternative combinations of roles may be generated by enumerating sets of device behaviors, calculating a measure of fitness for the sets, sorting the sets according to the measure of fitness, and eliminating the device behaviors based on the sort. In some embodiments, these sets of alternative roles may be permutations of the roles listed in role column 814. For example, as shown in panel 820, three sets of alternative roles are presented to the user, and each of these sets of alternative roles is a permutation of the roles listed in role column 814. In other embodiments, these sets of alternative roles may also include roles that were not listed in role column 814. For example, one or more of alternative role assignment columns 822, 824, and 826 may include the role “primary gaming device”, which is a role that is not listed in role column 814.

In some embodiments, one of more of the alternative role assignment columns may include a button that allows the user to select a particular alternative role assignment that will override the automatic optimal role assignment listed in panel 810. For example, as illustrated in FIG. 8, alternative role assignment columns 822, 824, and 826 each include a selection button 823, 825, and 827, respectively. In this example, if a user selected selection button 825, the set of roles listed under in alternative role assignment column 824 will override the automatic optimal role assignments listed in role column 814.

FIG. 9A shows an illustrative flow diagram of a process 910 for assigning roles to user devices in accordance with an embodiment of the invention. Although process 910 will be described as being performed by centralized user equipment, such as role server 507 (FIG. 5), it shall be understood that in an embodiment process 910 is be performed by one or more user equipment devices, such as user equipment devices 500. Process 910 begins at step 901. At step 901, device identifiers are received by role server 507. In some embodiments, these device identifiers may be broadcast by one or more user equipment devices, such as user equipment devices 500 (FIG. 5). In some embodiments, these device identifiers may be received over a communications path, such as communication paths 502, 504, and 506 (FIG. 5). In an embodiment, at step 901 a device identifier packet is received that includes the device identifiers. This device identifier packet may be substantially similar to one or more portions of device identifier packet 600 or all of device identifier packet 600 (FIG. 6). In such embodiments, the device identifier packet may be parsed in any suitable manner such that the device identifier itself is extracted and can be used in subsequent steps of process 910. In an embodiment, the device identifier may come in the form of a UUID that is substantially similar to UUID field 601. In other embodiments, the device identifier may be received in any suitable form separate from device identifier packet 600. For example, the device identifier may be received from any suitable storage device attached to role server 507 (e.g., a hard drive or portable storage).

In some embodiments, the received device identifiers may be stored on the role server or user equipment devices that perform process 910. In some embodiments, the received device identifiers may be stored in a database of device identifier information using any suitable database management system. In other embodiments, the device identifiers may be stored on any suitable storage device attached to the role server or user equipment devices that perform process 910. For example, a tablet computer may broadcast a device identifier over a wifi connection. This broadcast device identifier may be received using wifi-enabled communications circuitry on the user equipment device. The user equipment device may then interface with a database management system to store the received broadcast device identifier into a database in cloud resources accessible to the user equipment device.

In some embodiments, device identifiers may be received at step 901 for a finite period of time before process 910 proceeds to step 902. For example, process 910 may receive device identifiers for a period of five minutes before proceeding to step 902. In other embodiments, device identifiers may be received perpetually. In such embodiments, as these device identifiers are received, multiple steps associated with process 910 may run in parallel. For example, if three user equipment devices are detected in an initial five minute period, but then a fourth user equipment device is subsequently detected, two instances of step 901 may execute in parallel.

Process 910 proceeds to step 902. At step 902, role server 507 resolves the identity of the user equipment devices based on the received device identifiers. The identity of the user equipment devices may include one or more of the device type, device serial number, device model number, the maker of the device, or any suitable information that identifies the device to a home user. For example, the identity of a tablet computer may be resolved as “Apple iPad 2”. In some embodiments, the received device identifiers themselves may be sufficient to resolve the identity of a user equipment device. For example, role server 507 may receive a device identifier packet 600 that includes an UUID field 601 that can be read as “Apple iPad 2” without any further processing of the information in UUID field 601. In other embodiments, the received device identifiers may not be sufficient to determine one or more of the identities of the devices. In such embodiments, the information in the received device identifiers may be used to query a third party database. For example, a device identifier packet 600 may be received that includes an UUID field 601 that is a string of hexadecimal digits that corresponds to an Amazon Standard Identification Number, or ASIN. This ASIN may then be used to query a third party database, such as Amazon Product Advertising API. The query may then return a string identifying the type of the device in plain English.

In some embodiments, the received device identifiers may need to be analyzed in order to resolve the identities of the devices. For example, the received device identifiers may include an image taken by a front facing camera mounted on or integrated in to a television. This image may then be transmitted to role server 507 and analyzed using detecting circuitry 307 using any suitable computer vision technique or techniques in order to determine that there is a tablet computer (e.g., an iPad 2) on a coffee table in front of the television.

In some embodiments, the identity of the user equipment device may be resolved by estimating the device type based on the device identifiers. In an embodiment, the device type may be estimated based only on the other devices in the room and their identified device capabilities. In such embodiments, this information may be available from the various fields in a received device identifiers, e.g., a received device identifier packet. For example, a device identifier packet 600 that may be received that includes other known device data field 602 may indicate that an LCD television and a tablet computer are within a room. In addition, the other known device data field 602 may include information that indicates that the LCD television has display and sound capabilities superior to that of the tablet computer. That same received device identifier packet may also include an UUID field 601 that is blank, but a device capabilities field 604 that indicates that the capabilities of the user equipment device that broadcast the packet include wifi and cellular communications. The server may then deduce that the device that broadcast the device identifier packet is a smartphone, and may associate a generic “smartphone” device type to the device.

In some embodiments, the resolved identity of the device may be stored in one or more of the user equipment devices, or at a role server itself. In one example, the identity of a device may be resolved by a user equipment device itself (e.g., one of user equipment devices 500), and stored in a device identifier packet generated by the user equipment device in device type field 603. In another example, the identity of a device may be resolved by role server (e.g., role server 507), and may be stored in the device identifier packet broadcast by the device and received by the role server.

Process 910 then proceeds to step 903. At step 903, role server 507 determines the capabilities of the resolved devices. These device capabilities may be substantially similar to those described with respect to device capabilities field 604 (FIG. 6). In some embodiments, the capabilities of the resolved devices may be determined based on information obtained from step 902. In some embodiments, the capabilities of the resolved devices may be determined based on information in the received device identifiers, such as one or more fields in a received device identifier packet 600 (FIG. 6). For example, the received device identifiers may include a sound that was produced by one of the user equipment devices 500 in a room of the user's home. Role server 507 may analyze the sound to determine that it was a ringtone, and may then deduce that the device that produced the sound is a cell phone with the ability to receive calls, display caller identification, display media guidance reminders, display social media communications, or any other behavior associated with a profile setting. Role server 507 may also analyze the sound to produce a time difference of arrival value between the sound and role server 507, and may then use this value to deduce that the device is in a perceivable range of role server 507 and/or other user equipment within the vicinity of role server 507.

In an embodiment, the device capabilities may be determined based on the device types resolved at step 902. The resolved device types may be used to query a third party database that takes device types as input and returns device capabilities corresponding to the device types. For example, a device type resolved at step 902 may be used to query the Amazon Product Advertising API, which then returns a set of device capabilities that may then be stored in the device capabilities field 604 of a device identifier packet 600 that corresponds to the device associated with the device type.

In an embodiment, the device capabilities may be determined based on contextual information associated with the type and/or capabilities of other devices that have been detected by role server 507. For example, role server 507 may detect that there are three devices within a room. The type and capabilities of the two of the devices may be known. For example, role server 507 may have resolved the type of two of the devices to be a LCD television and a desktop computer through the process described with respect to step 902. Role server 507 may also have determined that the device capabilities of the television include video display and sound playback, and that the capabilities of the desktop computer include video display, sound playback, and internet browsing. Further, role server 507 may have determined that the device type of a third device in the room is a cellular telephone, but because the cell phone is a brand new model, it has not been successful in determining the device capabilities of the cell phone. However, the user of the cell phone has connected it to the desktop computer to upload photos and download Android market smartphone applications, and such actions were recorded in a log on the desktop computer. Role server 507 may access this log using any suitable communication path, and in doing so may determine that the smartphone has web browsing capabilities typical of most Android smartphones. As a result, role server 507 may assign the capability of “web browsing” and “photo capture” to the cell phone. These capabilities may then be stored in the device capabilities field 604 of a device identifier packet 600 that corresponds to the cell phone.

In some embodiments, both the device types resolved at step 902 and contextual information associated with the type and/or capabilities of other devices that have been detected by role server 507 may be used in tandem to determine the capabilities of one or more user equipment devices. However, in some embodiments this information may not be adequate to determine the capabilities of a particular user equipment device. In such embodiments, role server 507 may prompt the user for manual input in order to determine the device capabilities similar to resolve capabilities options 718, 728, and 738 (FIG. 7).

Process 910 proceeds to step 904. At step 904, the roles of the resolved devices are determined based on the device capabilities. In some embodiments, the device capabilities may be those that were determined at step 903. In some embodiments, these roles may be substantially similar to those described with respect to menu 800 (FIG. 8). In some embodiments, the server may assign roles to the resolved devices based on the capabilities of the devices by first enumerating sets of device behaviors associated with the devices. In one example, the server may calculate all permutations of device behaviors among the devices. Specifically, say the role server 507 has processed three device identifier packets corresponding to three user equipment devices, an tablet computer, a smartphone, and an LCD television. Role server 507 may then determine that based on the capabilities of these devices, that there are three main device behaviors that need to be translated into roles to be assigned to the devices—watching a movie, playing sound associated with that movie, and displaying information associated with that movie. Role server 507 may then enumerate six sets of permutations of these roles with respect to the three user equipment devices.

In an embodiment, the sets of enumerated device behaviors may be evaluated according to a measure of fitness. This measure of fitness may allow the sets of enumerated device behaviors to be sorted such that the set that provides the optimal user experience may be determined. In some embodiments, the measure of fitness may be based on predetermined optimal device behaviors. For example, a device manufacturer may preprogram role server 507 with a measure of fitness that allows larger display screens to be evaluated as having a higher measure of fitness for watching video and reproducing sound associated with the video. In some embodiments, the measure of fitness may be based on predetermined user settings. For example, a user may preprogram role server 507 with a measure of fitness that allows handheld display screens to be evaluated as having a higher measure of fitness for watching video and reproducing sound associated with the video. In some embodiments, the measure of fitness may be based on comparisons between the determined capabilities of the devices. Once the measures of fitness have been calculated, the sort of the device behaviors may be performed according to any suitable technique. In some embodiments, the sets of enumerated device behaviors may be eliminated based on the results of a sort.

In some embodiments, at step 904 the server may assign roles to the resolved devices based on the location of the devices. For example, the server may determine that a tablet computer and a laptop computer are within a perceivable range of a television using detecting circuitry 307 (FIG. 3). The server may then use this information to assign each of the television, laptop computer, and tablet computer the role of displaying media guidance reminders. In this manner, the roles ensure that there is a greater chance that a user will see the reminder if he is browsing the internet on his laptop or tablet computer while watching television. In some embodiments, the server may assign roles to the resolved devices based on both the capabilities and location of the devices in relation to each other. For example, the server may determine that a tablet computer is within a perceivable range of a television using detecting circuitry 307 (FIG. 3) of one or more of the devices. In addition, the server may determine that the tablet computer and the television are capable of displaying media guidance reminders, and that the display of the television is larger than the display of the tablet computer. The server may then use this information to assign the television the exclusive role of displaying reminders, as it is the largest screen out of any of the devices present in the room.

In some embodiments, the server may assign roles to the resolved devices based on both the capabilities of the devices and the location of the devices in relation to a user. For example, the server may determine that a smart phone is sitting in a user's lap, and that a tablet computer is sitting across the room from the user, using detecting circuitry 307 (FIG. 3) of one or more of the devices. In addition, the server may determine that the smart phone and the tablet computer can both play sound. The server may then use this information to assign the smart phone the exclusive role of playing sound associated with the requested playback of a media file on either the smart phone or tablet computer, as it is the closest device to the user that can play sound. In some embodiments, the server may assign roles to the resolved devices based on both the capabilities of the devices and the directional positioning or orientation of the device in relation to the user. For example, the server may determine that a first smart phone is placed to the left of the user, and that a second smart phone is placed to the right of the user, using detecting circuitry 307 (FIG. 3) of one or more of the devices. In addition, the server may determine that both the first and second smart phone can play sound. The server may then use this information to assign the first smart phone the role of left audio channel playback of audio associated with media files, and the second smart phone the role of right audio channel playback of audio associated with media files. In this manner, the role server takes advantage of the directional positioning of devices around the user to provide the user with an enhanced home entertainment experience.

In some embodiments, the server may change the assignment of roles if one or more of the devices leave (i.e., are no longer within) a perceivable range of each other. For example, remote server 507 may assign the exclusive role of displaying media guidance reminders to a television rather than a tablet computer as long as the tablet computer remains within the perceivable range of the television. If it is determined that the tablet computer is no longer within the perceivable range of the television, the tablet computer may be assigned the role of displaying the media guidance reminders instead of the television.

Process 910 then proceeds to step 905. At step 905, one or more requests to execute a device behavior may be received. These requests may correspond to any device behavior associated with home user entertainment. For example, these device behaviors may include playing a movie, listening to music, playing a game on a user equipment device, displaying a media guidance reminder, displaying a text message, displaying media guidance data, displaying caller identification information, or displaying social media communications. In one example, there may be three devices in a room: a tablet computer, a television, and a smartphone. A user may initiate the playback of a video on a media player application on the tablet computer. The request to play back the video may be transmitted by the tablet computer to a role server for further processing. In another example, there may be two devices in a room: a tablet computer and a television. A media guidance application implemented on user equipment connected to the display of the television may generate a media guidance reminder targeted at a particular user. This media guidance reminder may be routed by the media guidance application to role server 507 for further processing.

Process 910 then proceeds to step 906. At step 906, the requested device behavior that was received at step 905 may be enabled. In some embodiments, enabling the device behavior may include processing the requested device behavior at a role server to execute device functionality across several user equipment devices. These user equipment devices may include those that the role server has determined the device type and device capabilities for at steps 902, 903, and 904. In some embodiments, this processing may translate the requested device behavior into a different device behavior with respect to the user equipment device that requested the device behavior. Continuing the first example discussed with respect to step 905, once the role server receives the request to play video from the tablet computer, the role server may have already determined that the television is an optimal device for displaying the video and playing sound associated with the video (e.g., by assigning roles to the user equipment devices at step 904). Additionally, the role server may have determined that the tablet computer is an optimal device for displaying secondary information associated with that video (e.g., a web page related to the video), and that the smartphone is an optimal device for displaying a social media feed associated with that video (e.g., a twitter feed associated with a movie). According to these roles, the role server may translate the request to play back the video into three separate instructions: an instruction transmitted to the television to play back the video and reproduce sound associated with the video, an instruction transmitted to tablet computer to request and display a web page associated with the video, and an instruction transmitted to the smart phone to request and display a social media feed associated with the video. Process 910 then ends.

In some embodiments, at step 906 enabling the device behavior may include instructing a device to execute a profile setting. Continuing the second example discussed with respect to step 905, once role server 507 receives the request to display a media guidance reminder, role server 507 may have already determined that the television is an optimal device for displaying media guidance reminders as compared to the tablet computer. From this determination, role server 507 may assign roles that instruct the television to execute a profile setting that enables the display of media guidance reminders, and instruct the tablet computer to not execute a profile setting that disables the display of media guidance reminders. According to these roles, role server 507 may route the request to display the media guidance reminders such that media guidance reminders are displayed on the television rather than the tablet computer. In some embodiments, role server 507 may switch these roles if it determines that the tablet computer is no longer within the perceivable range of the television (the inference being that the user has carried the tablet computer outside of his viewing range of the television). Once role server 507 makes this determination, the reminders may be displayed on the tablet computer rather than the television.

FIG. 9B shows an illustrative flow diagram of a process 920 for assigning roles to user devices in accordance with an embodiment of the invention. Although process 920 will be described as being performed by centralized user equipment, such as role server 507 (FIG. 5), it shall be understood that in an embodiment process 920 is be performed by one or more user equipment devices, such as user equipment devices 500. Further, although process 920 will be described as assigning roles to two devices, it shall be understood that in other embodiments process 920 assigns roles to any suitable number of user equipment devices 500. Process 920 begins at step 911. At step 911, it is determined that a second device is within the perceivable range of a first device. In some embodiments, the perceivable range may be defined by role server 507 as a subset of a detection region. The detection region may be set according to the systems and methods of Shimy et al. U.S. Patent Publication No. 2011/0069940 (Docket No. UV-495A). Detecting circuitry 307 (FIG. 3) of one or more of the first and second devices may use any suitable method to determine the distance, trajectory, and/or location of the first and second user devices in relation to each other. This information may be transmitted to role server 507 in any suitable format, such as one or more fields of device identifier packet 600 (FIG. 6). Role server 507 may then use this information along with the defined detection region in order to determine whether the second device is within the perceivable range of the first device. In some embodiments, this determination may be made similar to the systems and methods described in U.S. Patent Publication No. 2011/0069940. In some embodiments, this determination may be made by analyzing data parsed from one or more received device identifier packets as will be described with respect to FIG. 9C.

In one example, a user's living room may contain a television and a tablet computer. Role server 507 may define the perceivable range as a trapezoidal area in front of the television. Detecting circuitry 307 of the television may use RSSI values obtained from Wi-Fi signals transmitted from the tablet computer to triangulate the tablet computer's position in relation to the television. Role server 507 may receive the triangulated location of the tablet computer, and compare the location to the defined trapezoidal area in order to determine whether the tablet computer is within the perceivable range of the television. In some embodiments, this determination may indicate whether a user viewing the television will also be able to view the screen of the tablet computer.

In another example, role server 507 may define the perceivable range according to a binary determination of whether an image taken by a front facing camera on the television contains the tablet computer. Detecting circuitry 307 of the tablet computer or the role server may analyze the image according to any suitable computer vision technique in order to determine whether the tablet computer is within the perceivable range of the television.

Process 920 proceeds to step 912. At step 912, the first device is assigned a primary device role and a second device is assigned a secondary device role. In an embodiment, these roles may be associated with profile settings. In particular, the roles may be associated with enabling or not enabling profile settings. As described above, these profile settings may enable the display of one or more of media guidance reminders, information associated with content availability, media guidance data, information associated with wired, cellular, internet based telephony, social media communications, or any other suitable information that is not the video and audio of presented content itself. In some embodiments, the roles may be assigned based on one or more of the capabilities and locations of the devices as discussed with respect to step 904 (FIG. 9). For example, the server may determine that a tablet computer is within a perceivable range of a television using detecting circuitry 307 (FIG. 3). In addition, the server may determine that the tablet computer and the television are capable of displaying media guidance reminders, and that the display of the television is larger than the display of the tablet computer. Using this information, the server may assign the role of primary reminder device to the television, and the role of secondary reminder device to the tablet computer. In some embodiments, these roles may be assigned according to steps 901, 902, 903, and 904 of process 910 (FIG. 9A). Process 920 proceeds to step 913.

At step 913, the first device may be instructed to execute a profile setting and the second device may be instructed to not execute that same profile setting. In some embodiments, executing the profile setting may include switching on or enabling the presentation of information on a particular user device, while not executing the profile setting may include switching off or disabling the presentation of information on a particular user device. In other embodiments, executing the profile setting may vary the frequency of information presented (e.g., vary the frequency of social media communications presented such that a subset of the social media communications directed toward the user associated with the particular user profile is displayed).

Continuing the example from step 912, remote server 507 has assigned the role of primary reminder device to the television, and the role of secondary reminder device to the tablet computer. The role of primary reminder device may instruct the television to execute a profile setting so as to enable the display of media guidance reminders on the television display, while the role of secondary reminder device may instruct the television to not execute a profile setting so as to disable the display of media guidance reminders on the tablet computer. In this manner, media guidance reminders are automatically displayed on the device in the room that is most suitable for the task and has a higher chance of being viewed by the user.

Process 920 proceeds to step 914. At step 914, it is determined that the second user device is no longer within the perceivable range of the first user device. In some embodiments, this determination may be based on an updated distance, trajectory, and/or location of the first and second devices in relation to each other subsequent to the determination of distance, trajectory, and/or location made at step 911. For example, detecting circuitry 307 (FIG. 3) of one or more of the first and second devices may use any suitable method to determine an updated distance, trajectory, and/or location of the first and second user devices in relation to each other. This information may be transmitted to role server 507 in any suitable format, such as one or more fields of device identifier packet 600 (FIG. 6). In some embodiments, role server 507 may then use this updated information along with a defined detection region in order to determine whether the second device is within the perceivable range of the first device. In some embodiments, this perceivable range may be substantially similar to that used to determine whether the second device is within the perceivable range of the first device at step 911. In an embodiment, the determination may be made based on the fact that the second device was previously within the perceivable range of the first device. For example, the determination may be made based on a data structure that indicates that the second device was within the perceivable range of the first device at a previous point in time.

Continuing the example from step 913, the user may carry his tablet computer away from the television to a different room of his home (e.g., his bedroom or bathroom). During or after the period of time in which tablet computer is moving between rooms, one or more of detecting circuitry 307 of the tablet computer and the television the server may determine an updated distance, trajectory, and/or location of the tablet computer in relation to the location of the television. One or more of the tablet computer and the television may send this updated information to role server 507, which may in turn compare the information against the defined trapezoidal area in front of the television. From this comparison, role server 507 may determine that the tablet computer is no longer within a perceivable range of the television.

Process 920 proceeds to step 915. At step 915, the roles of the first and second devices may be switched based on the determination made at step 914. Continuing the example from step 914, the server may switch the roles of the television and the tablet computer such that the television is now the secondary reminder device, and the tablet computer is the secondary reminder device. The role of secondary reminder device may instruct the television to not execute a profile setting so as to disable the display of media guidance reminders on the television, while the role of primary reminder device may instruct the table computer to execute a profile setting so as to enable the display of media guidance reminders on the tablet computer. In this manner, the roles of the user equipment devices are adjusted such that the user is delivered displays of information on the device that is most convenient to them.

In some embodiments, step 915 may determine that the second user device has subsequently returned to a location that is within the perceivable range of the first user device. In such embodiments, the roles assigned to the first user device and the second user device may be switched again such that they are in their original configuration (i.e., the original assignment made at step 912). For example, the user may carry his tablet computer back from the bathroom to the room where his television is located. As a result, the primary and secondary device reminder roles may be switched between the television and the tablet computer such that the television is once again displaying reminders instead of the tablet computer. Process 920 then ends.

FIG. 9C shows an illustrative flow diagram of a process 930 for assigning roles to user devices in accordance with an embodiment of the invention. Although process 920 will be described as being performed by centralized user equipment, such as role server 507 (FIG. 5), it shall be understood that in an embodiment process 930 is be performed by one or more user equipment devices, such as user equipment devices 500. Further, although process 930 will be described as assigning roles to two devices, it shall be understood that in other embodiments process 930 assigns roles to any suitable number of user equipment devices 500. Process 920 begins at step 921. At step 921, device identifiers associated with first and second user devices are received. In an embodiment, the device identifiers associated with the first and second identifiers may be received substantially similar to the process described with respect to step 901 (FIG. 9). Process 930 proceeds to step 922.

At step 922, the received device identifiers may be parsed in order to obtain information regarding the location of the first and second user device. In an embodiment, a received device identifier packet associated with either the first or second user equipment device may be parsed by the role server such that information associated with other devices in the room can be separated and analyzed in further processing. In some embodiments, this information may correspond to the information in other known device data field 602 in a device identifier packet 600 (FIG. 6). For example, this information may include one or more of a received signal strength indication between the first user device and the second user device, a time difference of arrival values of a sound emanating from the first user device to the second user device, or an image taken by the first user device. In some embodiments, this parsing may occur by reading a header in the device identifier packet that identifies the location and length of each of the other known device data field 602 in the device identifier packet. Process 930 proceeds to step 923.

At step 923, the parsed information is analyzed to determine that the second device is within the perceivable range of the first device. In an embodiment, the distance, trajectory, and/or location of the second user device in relation to the first user device may be calculated through triangulation. For example, this triangulation may analyze one or more of received signal strength indications between the first user device and the second user device, or a time difference of arrival values of a sound emanating from the first user device to the second user device. In some embodiments, the location of the second device may be detected by the first device by analyzing an image taken by the first user device using any suitable computer vision technique. Once the distance, trajectory, and/or location of the second device is determined, this information may be used in conjunction with a defined perceivable range (e.g., the perceivable range discussed with respect to step 911 of process 920 (FIG. 9B)) in order to determine whether the second device is within the perceivable range of the first device. In some embodiments, step 923 may determine whether the second device is no longer within the perceivable range of the first device. This determination may be made similar to that just described, except using information (e.g., a data structure) that indicates that the second device was within the perceivable range of the first device at a previous time. Process 930 then ends.

FIG. 10 shows an illustrative flow diagram of a process 1000 for assigning roles to user devices in accordance with an embodiment of the invention. Although process 1000 will be described as being performed by centralized user equipment, such as role server 507 (FIG. 5), it shall be understood that in an embodiment process 1000 is be performed by one or more user equipment devices, such as user equipment devices 500. Additionally, although process 1000 will be described as being performed with respect to a single user equipment device, it shall be understood that more than one instance of process 1000 may be performed by a role server or the user equipment devices concurrently. In some embodiments, process 1000 is executed as part of step 902 of process 910 (FIG. 9A). The goal of process 1000 is to determine the device type of a user equipment device. Process 1000 begins at step 1010. At step 1010, a received device identifier packet associated with a user equipment device may be parsed by the role server such that information associated with UUID, device type, other devices in the room, and device capabilities can be separated and analyzed in further processing. In some embodiments, this information may correspond to the information in fields 601 through 604 in a device identifier packet 600 (FIG. 6). In some embodiments, this parsing may occur by reading a header in the device identifier packet that identifies the location and length of each of the fields 601 through 604 in the device identifier packet. Process 1000 may proceed to step 1020.

At step 1020, it is determined whether the device type has been resolved. In some embodiments, the device type may be resolved if the information obtained from parsing the device identifier packet at step 1010 immediately indicates the device type. For example, the device type field from a received device identifier packet may directly indicate the make and model of a user equipment device, such as “Apple iPad 2” or “Samsung Galaxy Nexus phone”. In some embodiments, the device type field may already be populated when the device identifier packet is received. In such embodiments, the device type field may be populated by the manufacturer of the device, through user input, or any other suitable means. If the device type has been resolved, process 1000 proceeds to step 903 (FIG. 9A). Otherwise, process 1000 proceeds to step 1030.

At step 1030, third party databases are queried based on the parsed information. In some embodiments, the information in the UUID field may be used to query a third party database. In such embodiments, the UUID field may not directly indicate the type of the device, but third party databases are able to translate the UUID into a device type. Such translation may occur using, for example, the Amazon Product Advertising API as described with respect to step 902 (FIG. 9A). However, it shall be understood that any suitable database that can match input UUIDs to device types may be used. Process 1000 proceeds to step 1040.

At step 1040, the results of the query to the third party databases are analyzed to determine whether the device type has been resolved. In some embodiments, it is determined that the device type has been resolved when the result of the queries to third party databases are strings of text that indicate a device type, such as “Apple iPad 2”, “Samsung Galaxy Nexus”, or any other suitable identifier. In some embodiments, it is determined that the device type has not been resolved when the result of the queries to third party databases indicate that a device type could not be found (e.g., a string indicating an error message or “NaN”), or that the returns from the queries are inconsistent (e.g., the return of one query indicates that the device is a first generation iPad, while the result of another query indicates that the device is a second generation iPad). If the device type has been resolved, process 1000 proceeds to step 903 (FIG. 9A). Otherwise, process 1000 proceeds to step 1050.

At step 1050, the device type may be estimated based on contextual information. In some embodiments, this contextual information may include an image taken by a device of other objects in a room. This image may be analyzed using any suitable computer vision technique in order to pick out the logos or textual markings of other devices within the room (e.g., the Apple logo, or text indicating a brand name). In other embodiments, the contextual information may include information in the received device identifier packet that indicates the capabilities of the user device (e.g., device capabilities field 604 is pre-populated by the device manufacturer, or is automatically populated during operation of that device), but does not contain information that indicates the device type or that is useful in indicating the device type (e.g., UUID field 601 is not populated). For example, a received device identifier packet may indicate that the user equipment device is capable of wifi and cellular communication, but has a 4 inch display screen. The role server may then use this information to estimate that the device type is a smartphone by comparing these capabilities to the capabilities of other user equipment devices it has assigned roles to in the past. For example, the role server may have assigned roles to several other different types of smartphones with the same capabilities in the past, and by comparison may determine that the unidentified user equipment device is a smartphone. In such embodiments, the role server may assign a generic device type (e.g., “smartphone” or “tablet computer”) to the device rather than a device type that indicates the make and model of the device (e.g., “Samsung Galaxy Nexus” or “Apple iPad 2”). Process 1000 proceeds to step 1060

At step 1060, it is determined whether the device type has been resolved as a result of the estimation at step 1050. In some embodiments, it may be determined that the device type has been resolved if the estimation results in the determination of a generic device type as described above. If the device type has been resolved, process 1000 proceeds to step 903 (FIG. 9A). Otherwise, process 1000 proceeds to step 1070.

At step 1070, the user may be prompted to manually input the type of the user device. This manual input may be substantially similar to that discussed with respect to resolve capabilities options 718, 728, and 738 (FIG. 7). Once manual user input has been collected, process 1000 then ends.

FIG. 11 shows an illustrative flow diagram of a process 1100 for assigning roles to user devices in accordance with an embodiment of the invention. Although process 1100 will be described as being performed by centralized user equipment, such as role server 507 (FIG. 5), it shall be understood that in an embodiment process 1100 is be performed by one or more user equipment devices, such as user equipment devices 500. Additionally, although process 1100 will be described as being performed with respect to a single user equipment device, it shall be understood that more than one instance of process 1100 may be performed by a role server or the user equipment devices concurrently. In some embodiments, process 1100 is executed as part of step 904 of process 910 (FIG. 9A). The goal of process 1100 is to determine the roles of user equipment devices based on the capabilities of the devices. In some embodiments, the device capabilities may be those resolved at step 903 of process 910.

Process 1100 begins at step 1110. At step 1110, sets of device behaviors are enumerated. In some embodiments, these sets of device behaviors may be enumerated by creating permutations of device behaviors among the devices as described with respect to step 904 of process 910. In other embodiments, these sets of device behaviors may be enumerated according to preset configurations. These preset configurations may be created by the manufacturers of the user equipment (e.g., Apple, Samsung, or Sharp), the distributors of the user equipment (e.g., a retail store such as Best Buy of Fry's), or any other suitable provider of home entertainment equipment. Process 1100 proceeds to step 1120.

At step 1120, a measure of fitness is calculated for each of the sets of device behaviors based on the determined capabilities of the devices. In an embodiment, the measure of fitness may be based on a comparison between the determined capabilities of the devices as described with respect to step 904 of process 910. For example, the measure of fitness may compare the video display and sound reproduction capabilities of each user equipment device. In particular, a measure of display quality that takes into account display resolution, display size, and display brightness may be calculated for each user equipment device that has a display. In some embodiments, the individual components in the calculation of display quality may be weighted (e.g., display size may be weighted higher than display resolution and display brightness). Further, a measure of sound quality may be calculated which takes into account the dynamic range and volume of sound reproduction for each user equipment device that has speakers. In other embodiments (not shown), the measure of fitness calculated at step 1120 may be based on predetermined optimal device behaviors or predetermined user settings as described with respect to step 904 of process 910. Process 1100 proceeds to step 1130.

At step 1130, the enumerated device behaviors may be sorted based on the calculated measures of fitness. This sort may be performed according to any suitable technique. Process 1100 proceeds to step 1140. At step 1140, enumerated device behaviors may be eliminated based on the results of the sort at step 1130. For example, the sets of enumerated device behaviors that correspond to the bottom half of the sort may be eliminated and not displayed to the user in menu 800 (FIG. 8). In some embodiments, the sets of device behaviors may be eliminated based on user input. In one example, a menu may present the user with the results of the sort, and the user may then eliminate certain sets of device behaviors manually. In another example, a menu may present the user with unsorted sets of device behaviors, and the user may then eliminate certain sets of device behaviors manually. Once the user eliminated sets of device behaviors, additional measures of fitness may be calculated and additional sorts may be performed. In some embodiments, once certain sets of device behaviors are eliminated, the measures of fitness may be calculated differently than they were before the elimination. For example, the measure of fitness may be calculated the first time based on predetermined optimal device behaviors, and may be calculated the second time based on comparisons between device capabilities. Process 1100 proceeds to optional step 1150, or ends.

At optional step 1150, device behaviors may be selected based on user input. In some embodiments, the sets of device behaviors selected by the user input may be set as the role assignments. This selection may occur according to the selection of selection buttons 823, 825, and 827 described with respect to menu 800 (FIG. 8). Process 1100 then ends.

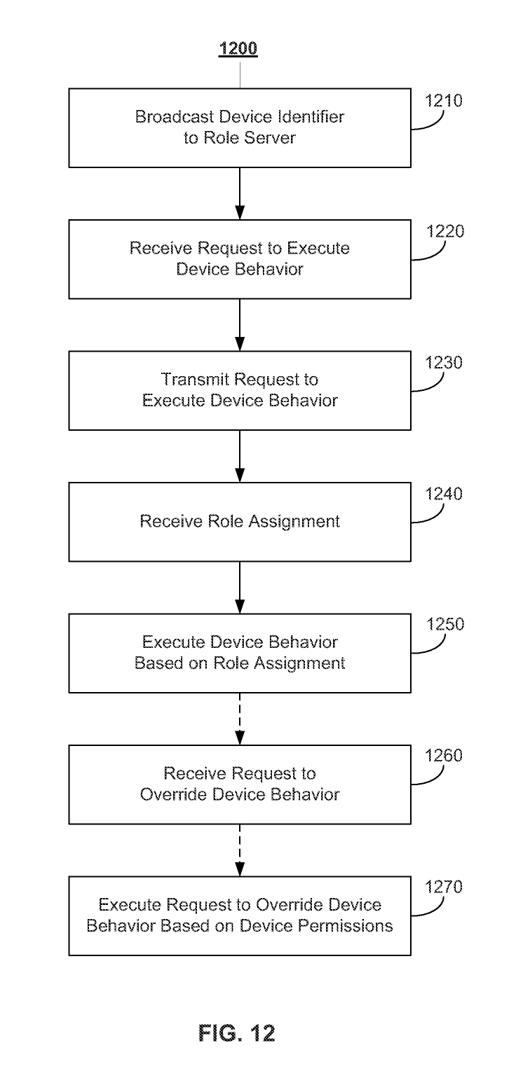

FIG. 12 shows an illustrative flow diagram of a process 1200 for assigning roles to user devices in accordance with an embodiment of the invention. Although process 1200 will be described as being performed with respect to a single user equipment device, it shall be understood that more than one instance of process 1200 may be performed by more than one of the user equipment devices concurrently. Process 1200 shows how roles are assigned to user equipment devices similar to process 910, but from the perspective of the user equipment device.

Process 1200 begins at step 1210. At step 1210, device identifiers may be broadcast by the user equipment device to the role server. In some embodiments, the device identifiers may be substantially similar to the information in device identifier packet 600 (FIG. 6). This communication may occur over any suitable communication paths, such as communication paths 502, 504, and 506. In an embodiment, the user equipment device may periodically broadcast the device identifiers for an indefinite period of time. For example, the user equipment device may broadcast the device identifiers every 30 seconds as long as the wifi communications circuitry of that user equipment device is available for transmitting data. In an embodiment, the user equipment device may only broadcast the device identifiers for a set period of time. For example, the user equipment device may only broadcast the device identifiers every 30 seconds for the first five minutes after the wifi communications circuitry of that user equipment device is activated. Process 1200 proceeds to step 1220.

At step 1220, a request is received to execute a device behavior. This request may be substantially similar to that described with respect to step 905 of process 910, or step 913 of process 920. Process 1200 proceeds to step 1230. At step 1230, the request to execute the device behavior may be transmitted. In some embodiments, this transmission may be received by a role server as described with respect to step 905 of process 910, or step 913 of process 920. Process 1200 proceeds to step 1240. At step 1240, the user equipment device receives a role assignment. In some embodiments, the role assignment may be generated by the role server in a process similar to step 904 of process 910, steps 912 or 915 of process 920, or the entirety of process 1100. In some embodiments, the role assignment may instruct the user equipment device how to translate the device behavior requested at step 1230 into a different device behavior. Process 1200 proceeds to step 1250.

At step 1250, the device behavior requested at step 1230 may be executed based on the role assignment. In some embodiments, the execution of the device behavior may be different than the device behavior initially requested by the user, but may provide for a more enjoyable home entertainment experience across the user equipment devices in a room in the user's home or apartment. In one example, the role server may determine that another user equipment device in the room would be an optimal device for displaying a video and playing sound associated with that video. Concurrently, the server may determine that the user equipment device would be an optimal device for displaying secondary information associated with that video (e.g., a web page related to the video). Accordingly, when a user presses “play” in the user interface of a video player on the user equipment device, the display and sound associated with that video may be transferred and displayed on the other device in the room, while a web browser may be automatically directed to a web page related to the video on the user equipment device. Accordingly, although this device behavior is different than the one the user initially requested, the user is provided with a more enjoyable home entertainment experience (i.e., because the user is watching the video on a larger screen with more powerful speakers while simultaneously browsing information related to the video on a smaller screen) Process 1200 proceeds to optional step 1260.

The above described embodiments of the invention are presented for purposes of illustration and not of limitation. The following claims give additional embodiments of the present invention.

1. A method for determining which of two user equipment devices is assigned a primary device role or a secondary device role, the method comprising:
determining that a second of the two devices is within a perceivable range of a first of the two devices;
in response to the determination, assigning the first device the primary device role and the secondary device the secondary device role, wherein the primary device role instructs the first device to execute a profile setting on the first device, and the secondary device role instructs the second device to not execute the profile setting on the second device;
determining that the second user equipment device is no longer within the perceivable range of the first user equipment device; and
in response to determining that the second user device is no longer within the perceivable range of the first user device, switching the assigned primary and secondary roles.

2. The method of claim 1, wherein determining that the second of the two user devices is within the perceivable range of the first of the two user devices further comprises:
receiving device identifiers associated with the first and second user equipment devices;
parsing the received device identifiers to obtain information regarding the location of the first and second user device; and
analyzing the parsed information to determine that the second of the two user equipment devices is within the perceivable range of the first device.

3. The method of claim 2, wherein the parsed information further comprises at least one of a received signal strength indication between the first user device and the second user device, a time difference of arrival values of a sound emanating from the first user device to the second user device, or an image.

4. The method of claim 3, wherein analyzing the parsed information comprises triangulating the location of the first device based on at least one of a received signal strength indication between the first user device and the second user device, or a time difference of arrival values of a sound emanating from the first user device to the second user device.

5. The method of claim 3, wherein analyzing the parsed information comprises applying a computer vision technique to the image.

6. The method of claim 1, wherein the profile setting comprises at least one of: enabling the presentation of media guidance data, enabling media guidance reminders to be displayed, enabling text messages to be displayed, enabling content availability information to be displayed, enabling media guidance data to be displayed, enabling caller identification information to be displayed, or enabling social media communications to be displayed.

7. The method of claim 1, wherein assigning the first device the primary device role and the secondary device the secondary device role further comprises:
receiving device identifiers associated with the two user devices;
resolving the type of the at two user devices based on the received device identifiers
determining capabilities of the two user devices based at least in part on the resolved type of the two user devices; and
assigning one or more roles to the two user devices based on the determined capabilities and the determination that the second device is within the perceivable range of the first device.

8. The method of claim 7, wherein resolving the type of the at least two devices further comprises:
parsing the received device identifiers to obtain device type information;
querying a third party database with the device type information; and
resolving the type of one of the at least two devices based on results of the query.

9. The method of claim 8, wherein the device type information comprises at least one of device type, other devices in a room, and device capabilities.

10. The method of claim 9, further comprising estimating device type based only on device type information consisting of the other devices in the room and device capabilities.

11. The method of claim 8, wherein resolving the type of the at least two devices further comprises receiving user input consisting of the device type of one of the at least two user devices.

12. The method of claim 8, wherein determining capabilities of the at least two devices based at least in part on the resolved type of the at least two devices further comprises:
querying a third party database with the resolved type of one of the at least two devices;
automatically determining capabilities of the one of the at least two devices based on results of the query.

13. The method of claim 8, wherein determining capabilities of the at least two devices based at least in part on the resolved type of the at least two devices further comprises receiving user input consisting of the capabilities of one of the at least two devices, wherein the user input is limited by the resolved type of the at least two devices.

14. The method of claim 8, wherein assigning one or more roles to the at least two devices based on the determined capabilities further comprises:
enumerating sets of device behaviors associated with the at least two devices; and
calculating a measure of fitness for each of the sets of device behaviors based on the determined capabilities;
sorting the sets of enumerated device behaviors based on the calculated measures of fitness.

15. The method of claim 14, further comprising eliminating one of the sets of enumerated device behaviors based on the sort of the sets of enumerated device behaviors.

16. The method of claim 14, further comprising eliminating one of the sets of enumerated behaviors based on a user selection.

17. The method of claim 14, wherein the measure of fitness is based on at least one of predetermined optimal device behaviors, predetermined user settings, and comparisons between the determined capabilities of the at least two devices.

18. A server for determining which of two user equipment devices is assigned a primary device role or a secondary device role, the server comprising detecting circuitry and processing circuitry, wherein the server is configured to:
determine using the detecting circuitry that a second of the two devices is within a perceivable range of a first of the two devices;
in response to the determination, assign the first device the primary device role and the secondary device the secondary device role using the processing circuitry, wherein the primary device role instructs the first device to execute a profile setting on the first device, and the secondary device role instructs the second device to not execute the profile setting on the second device;
determine using the detecting circuitry that the second user equipment device is no longer within the perceivable range of the first user equipment device; and
in response to determining that the second user device is no longer within the perceivable range of the first user device, switch the assigned primary and secondary roles.

19. The server of claim 18, wherein the processing circuitry is further configured to:
receive device identifiers associated with the first and second user equipment devices;
parse the received device identifiers to obtain information regarding the location of the first and second user device; and
analyze the parsed information to determine that the second of the two user equipment devices is within the perceivable range of the first device.

20. The server of claim 19, wherein the parsed information further comprises at least one of a received signal strength indication between the first user device and the second user device, a time difference of arrival values of a sound emanating from the first user device to the second user device, or an image.

21. The server of claim 20, wherein analyzing the parsed information comprises triangulating the location of the first device based on at least one of a received signal strength indication between the first user device and the second user device, or a time difference of arrival values of a sound emanating from the first user device to the second user device.

22. The server of claim 20, wherein analyzing the parsed information comprises applying a computer vision technique to the image.

23. The server of claim 18, wherein the profile setting comprises at least one of: enabling the presentation of media guidance data, enabling media guidance reminders to be displayed, enabling text messages to be displayed, enabling content availability information to be displayed, enabling media guidance data to be displayed, enabling caller identification information to be displayed, or enabling social media communications to be displayed.

24. The server of claim 18, wherein the processing circuitry is further configured to assign the first device the primary device role and the secondary device the secondary device role by:
receiving device identifiers associated with the two user devices;
resolving the type of the at two user devices based on the received device identifiers
determining capabilities of the two user devices based at least in part on the resolved type of the two user devices; and
assigning one or more roles to the two user devices based on the determined capabilities and the determination that the second device is within the perceivable range of the first device.

25. The server of claim 24, wherein the processing circuitry is further configured to resolve the type of the at least two devices by:
parsing the received device identifiers to obtain device type information;
querying a third party database with the device type information; and
resolving the type of one of the at least two devices based on results of the query.

26. The server of claim 25, wherein the device type information comprises at least one of device type, other devices in a room, and device capabilities.

27. The server of claim 26, wherein the processing circuitry is further configured to estimate device type based only on device type information consisting of the other devices in the room and device capabilities.

28. The server of claim 24, wherein the processing circuitry is further configured to resolve the type of the at least two devices further by receiving user input consisting of the device type of one of the at least two user devices.

29. The server of claim 24, wherein the processing circuitry is further configured to determine capabilities of the at least two devices based at least in part on the resolved type of the at least two devices further by:
querying a third party database with the resolved type of one of the at least two devices;
automatically determining capabilities of the one of the at least two devices based on results of the query.

30. The server of claim 24, wherein the processing circuitry is further configured to determine capabilities of the at least two devices based at least in part on the resolved type of the at least two devices by receiving user input consisting of the capabilities of one of the at least two devices, wherein the user input is limited by the resolved type of the at least two devices.

31. The server of claim 24, wherein the processing circuitry is further configured to assign one or more roles to the at least two devices based on the determined capabilities by:
enumerating sets of device behaviors associated with the at least two devices; and
calculating a measure of fitness for each of the sets of device behaviors based on the determined capabilities;
sorting the sets of enumerated device behaviors based on the calculated measures of fitness.

32. The server of claim 31, wherein the processing circuitry is further configured to eliminate one of the sets of enumerated device behaviors based on the sort of the sets of enumerated device behaviors.

33. The server of claim 31, wherein the processing circuitry is further configured to eliminate one of the sets of enumerated behaviors based on a user selection.

34. The server of claim 31, wherein the measure of fitness is based on at least one of predetermined optimal device behaviors, predetermined user settings, and comparisons between the determined capabilities of the at least two devices.

35-51. (canceled)
